(19) United States
(12) Patent Application Publication
(10) Pub. No.: US 2016/0055789 A1
(43) Pub. Date: Feb. 25, 2016

(54) DISPLAY PAEL

(71) Applicant: InnoLux Corporation, Miao-Li County (TW)

(72) Inventor: Kazuyuki HASHIMOTO, Miao-Li County (TW)

(21) Appl. No.: 14/464,313

(22) Filed: Aug. 20, 2014

(51) Int. Cl. G09G 3/20

(52) U.S. Cl. CPC G09G 3/2092; G09G 2310/0297; G09G 2310/0275

(57) ABSTRACT

A display panel comprises: a data driver unit; a first de-multiplexer unit; a plurality of first data lines connected between the data driver unit and an input terminal of the first de-multiplexer unit; and a plurality of second data lines connected to an output terminal of the first de-multiplexer unit.

### BACKGROUND OF THE INVENTION

### Field of the Invention

The present disclosure relates to a display panel.

### SUMMARY OF THE INVENTION

The object of the present invention is to provide a display panel capable of avoiding the conflict between the circuits inside the display panel.

To achieve the object, there is provided a display panel, which comprises: a data driver unit; a first de-multiplexer unit; a plurality of first data lines connected between the data driver unit and an input terminal of the first de-multiplexer unit; and a plurality of second data lines connected to an output terminal of the first de-multiplexer unit.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a display panel according to a first embodiment of the present invention;

FIG. 2A schematically illustrates an operation of a right half part of the display panel according to the present invention;

FIG. 2B schematically illustrates a circuit of the right half part of the display panel according to the present invention;

FIG. 3 schematically illustrates the timing of the right half part of the display panel according to the present invention;

FIG. 4A schematically illustrates an operation of a left half part of the display panel according to the present invention;

FIG. 4B schematically illustrates a circuit of the left half part of the display panel according to the present invention;

FIG. 5 schematically illustrates the timing of the left half part of the display panel according to the present invention;

FIG. 6 is a schematic diagram of a display panel according to a second embodiment of the present invention; and

FIG. 7 is a schematic diagram illustrating (A) a display panel according to a third embodiment of the present invention, and (B) a prior display panel for comparison.

### DETAILED DESCRIPTION OF THE PREFERRED EMBODIMENT

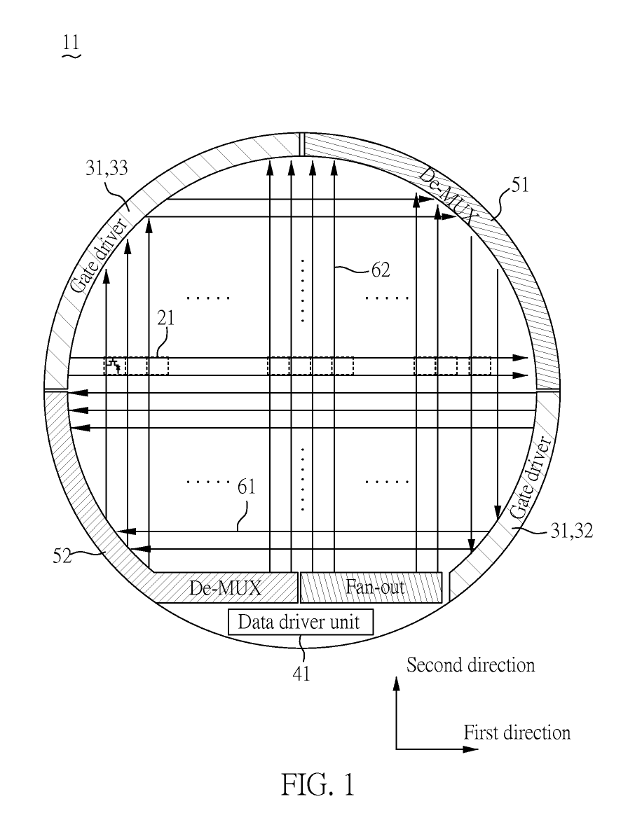

FIG. 1 is a schematic diagram of a display panel according to a first embodiment of the present invention. The display panel 11 comprises: a plurality of pixel 21, a gate driver 31, a data driver unit 41, a first de-multiplexer unit (De-MUX) 51, a second de-multiplexer unit 52, a plurality of gate lines 61, and a plurality of data lines 62. The plurality of pixels 21 are arranged in columns and rows, and each of the plurality of pixels 21 is connected with one of the plurality of gate lines 61 and one of the plurality of data lines 62. The gate driver 31 is coupled to the plurality of gate lines 61 for driving the plurality of pixels 21. The plurality of gate lines 61 are arranged in a first direction, the plurality of data lines 62 are arranged in a second direction, and the first direction is not parallel with the second direction, preferably the first direction being orthogonal with the second direction. The plurality of pixels 21 include red pixels, green pixels, and blue pixels.

In this embodiment, the display panel 11 is a round shaped display panel. The gate driver 31 includes a first driving unit 32 and a second driving unit 33. With respect to such a round shape, the first driving unit 32 and the second driving unit 33 are respectively disposed at two circumferential portions of the round shape substantially opposite to each other, and the first de-multiplexer unit 51 and the second de-multiplexer unit 52 are respectively disposed at two circumferential portions of the round shape substantially opposite to each other. The first driving unit 32 is coupled to the second driving unit 33 for providing a driving signal to drive the plurality of pixels 21 coupled to the second driving unit 33. With respect to the plurality of pixels 21, the first driving unit 32 is arranged at the right-bottom of the plurality of pixels 21 and the second driving unit 33 is arranged at the left-top of the plurality of pixels 21, and the first de-multiplexer unit 51 is arranged at the right-top of the plurality of pixels 21 and the second de-multiplexer unit 52 is arranged at the left-bottom of the plurality of pixels 21.

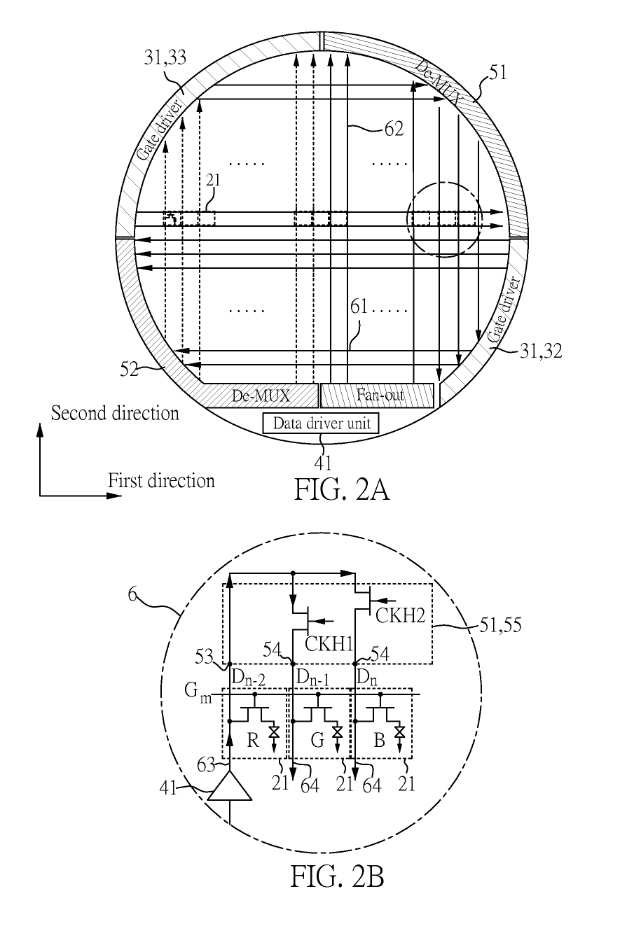

FIGS. 2A and 2B schematically illustrate an operation and a circuit of a right half part of the display panel according to the present invention. The dashed circle 6 in FIG. 2B is shown as the dashed circle in FIG. 2A. The plurality of data lines 62 include a plurality of first data lines 63 connected between the data driver unit 41 and an input terminal 53 of the first de-multiplexer unit 51 and a plurality of second data lines 64 connected to an output terminal 54 of the first de-multiplexer unit 51. The first de-multiplexer unit 51 includes at least one first de-multiplexer 55. The first de-multiplexer 55 includes an input node 53 and a plurality of output nodes 54. The input node 53 is connected to one of the first data lines 63 and the plurality of output nodes 54 are connected to the plurality of the second data lines 64. As shown in FIG. 2B, the first de-multiplexer 55 is connected to the data driver unit 41 via a data line Dₙ₋₂ for receiving a data signal from the data driver unit 41 and providing one of three pixels 21 with the data signal once.

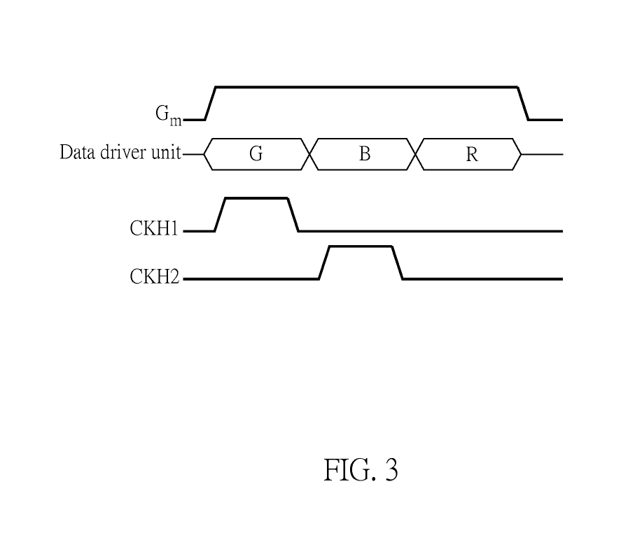

FIG. 3 schematically illustrates the timing of the right half part of the display panel according to the present invention. As shown in FIGS. 2B and 3, the first de-multiplexer 55 is coupled to a first clock signal to selectively provide one of the plurality of output nodes 54 with a first data signal from the data driver unit 41. The data driver unit 41 then provides one of the plurality of first data lines 63 with a second data signal. The timing of the first data signal is earlier than the timing of the second data signal. The data driver unit 41 provides the first de-multiplexer 55 with the first and second data signal via the data line Dₙ while the gate driver 31 drives the pixels 21 via the gate line Gₘ, wherein the first and second data signal include red (R), green (G), and blue (B) signal. The clock first provides the first clock signal CKH1 so that the green signal (the first data signal) is provided to the pixel (G green) 21 and then provides the first clock signal CKH2 so that the blue signal (the first data signal) is provided to the pixel (B, blue) 21, and after that the data driver unit 41 directly provides the red signal (the second data signal) to the pixel (R, red) 21.

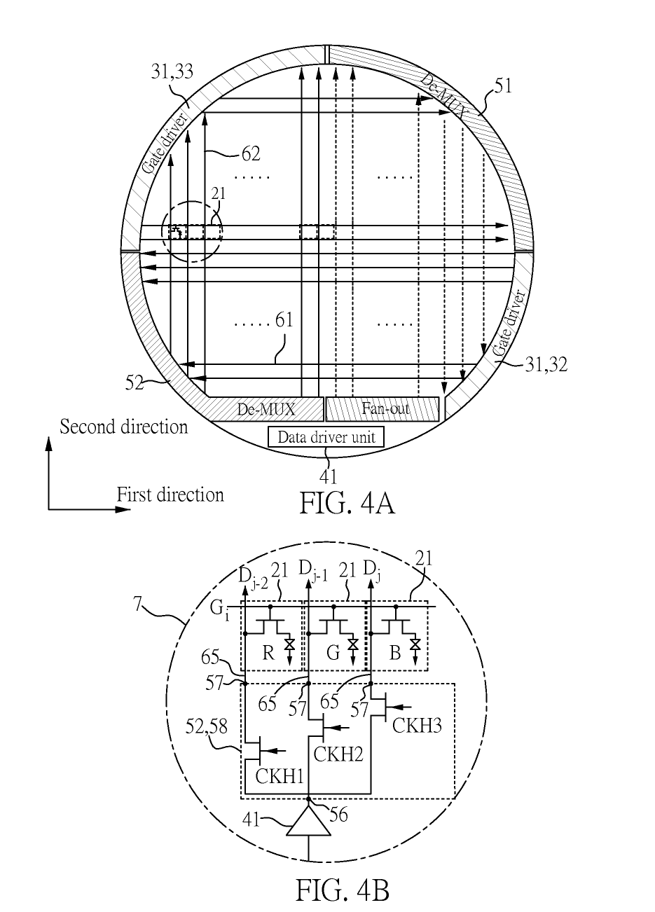

FIGS. 4A and 4B schematically illustrate an operation and a circuit of a left half part of the display panel according to the present invention. The dashed circle 7 in FIG. 4B is shown as the dashed circle in FIG. 4A. The plurality of data lines 62 further include a plurality of third data lines 65. An input terminal 56 of the second de-multiplexer unit 52 is connected to the data driver unit 41 and an output terminal 57 of the second de-multiplexer unit 52 is connected to the plurality of third data lines 65. The second de-multiplexer unit 52 includes at least one second de-multiplexer 58. The second de-multiplexer 58 is connected to the plurality of third data lines 65. As shown in FIG. 4B, the second de-multiplexer 58 is directly connected to the data driver unit 41 for receiving a data signal from the data driver unit 41 and providing one of three pixels 21 with the data signal once.

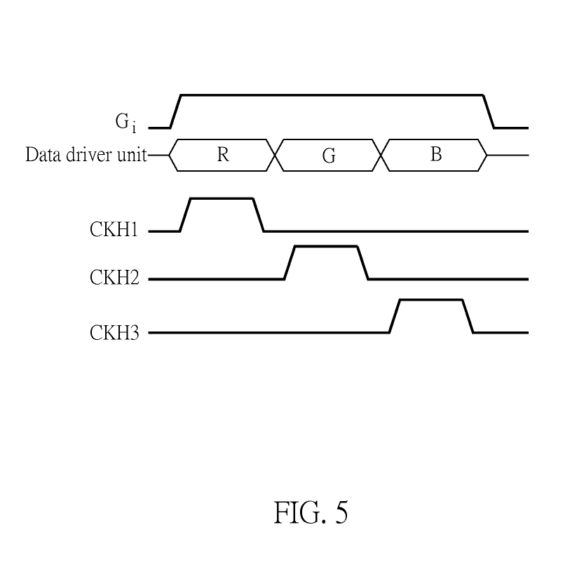

FIG. 5 schematically illustrates the timing of the left half part of the display panel according to the present invention. As shown in FIGS. 4B and 5, the second de-multiplexer 58 is coupled to a second clock signal to selectively drive one of the plurality of third data lines 65. The data driver unit 41 directly provides the second de-multiplexer 58 with the first data signal while the gate driver 31 drives the pixels 21 via the gate line G, wherein the first data signal includes red (R), green (G), and blue (B) signal. The clock first provides the first clock signal CKH1 so that the red signal is provided to the pixel (R, red) 21, then provides the first clock signal CKH2 so that the green signal is provided to the pixel (G green) 21, and finally provides the first clock signal CKH3 so that the blue signal is provided to the pixel (B, blue) 21.

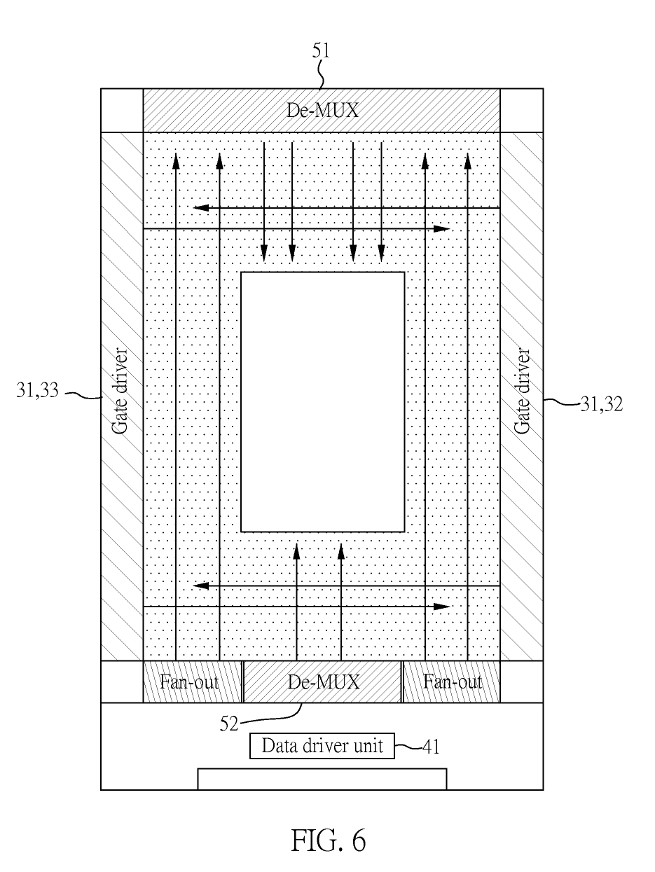

FIG. 6 is a schematic diagram of a display panel according to a second embodiment of the present invention. The display panel is a rectangle shaped display panel having a hole in its center. The gate driver 31 includes a first driving unit 32 arranged at a first side of a plurality of pixels (not shown) and a second driving unit 33 arranged at a second side of the plurality of pixels opposite to the first side. The first de-multiplexer unit 51 is arranged at the top of the plurality of pixels and the second de-multiplexer unit 52 is arranged at the bottom of the plurality of pixels. The functions of the first de-multiplexer unit 51 and the second de-multiplexer unit 52 are the same as those of the first embodiment.

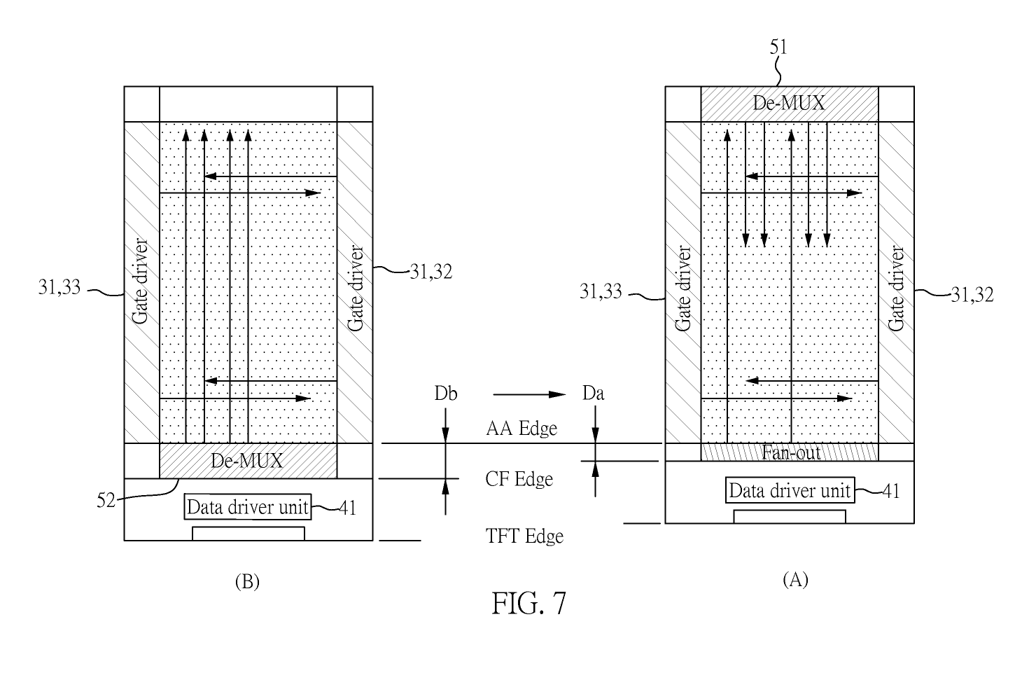

FIG. 7 is a schematic diagram illustrating (A) a display panel according to a third embodiment of the present invention, and (B) a prior display panel for comparison. The display panel of this embodiment is a rectangle shaped display panel. The de-multiplexer unit 51 is arranged at the top of a plurality of pixels (not shown) and thus is opposite to the data driver unit 41. The gate driver 31 includes a first driving unit 32 arranged at a first side of the plurality of pixels and a second driving unit 33 arranged at a second side of the plurality of pixels, wherein the second side is opposite to the first side. The function of the de-multiplexer unit 51 is the same as the first de-multiplexer of the first embodiment. In comparison, the de-multiplexer unit 52 of the prior display panel is arranged at the bottom of a plurality of pixels (not shown), right above the data driver unit 41. In other words, the de-multiplexer unit 52 of the prior display panel is replaced with small fan-out area then bottom boarder can be shrunk. Therefore, as shown in FIG. 7, the size of the bottom edge of the display panel can be reduced from Db to Da (Db>Da), thereby providing a narrow-border display panel.

Although the present invention has been explained in relation to its preferred embodiment, it is to be understood that many other possible modifications and variations can be made without departing from the spirit and scope of the invention as hereinafter claimed.

1. A display panel, comprising:
a display area comprising a plurality of pixels;
a data driver unit;
a first de-multiplexer unit;
a plurality of first data lines connected between the data driver unit and an input terminal of the first de-multiplexer unit; and
a plurality of second data lines connected to an output terminal of the first de-multiplexer unit
wherein the pixels are connected to the first data lines and the second data lines, and the display area is disposed between the data driver unit and the first de-multiplexer unit.

2. The display panel of claim 1, further comprising a plurality of third data lines and a second de-multiplexer unit, wherein an input terminal of the second de-multiplexer unit is connected to the data driver unit and an output terminal of the second de-multiplexer unit is connected to the plurality of third data lines.

3. The display panel of claim 1, wherein the first de-multiplexer unit includes at least one first de-multiplexer.

4. The display panel of claim 3, wherein the first de-multiplexer includes an input node and a plurality of output nodes.

5. The display panel of claim 4, wherein the input node is connected to one of the first data lines and the plurality of output nodes are connected to the plurality of the second data lines.

6. The display panel of claim 5, wherein the first de-multiplexer is coupled to a first clock signal to selectively provide one of the plurality of output nodes with a first data signal from the data driver unit.

7. The display panel of claim 6, wherein the data driver unit provides one of the plurality of first data lines with a second data signal.

8. The display panel of claim 7, wherein the timing of the first data signal is earlier than the timing of the second data signal.

9. The display panel of claim 2, wherein the second de-multiplexer unit includes at least one second de-multiplexer.

10. The display panel of claim 9, wherein the second de-multiplexer is connected to the plurality of third data lines.

11. The display panel of claim 10, wherein the second de-multiplexer is coupled to a clock signal to selectively drive one of the plurality of third data lines.
